(19) United States
(12) Patent Application Publication
(10) Pub. No.: US 2024/0275477 A1
(43) Pub. Date: Aug. 15, 2024

(54) RV-BASED MOBILE BASE STATION SYSTEM

(71) Applicant: A&C FUTURE, INC., Newport Beach, CA (US)

(72) Inventors: Shoue CHEN, Irvine, CA (US); Zhuangboyu Zhou, Santa Ana, CA (US); Xunmin Jiang, Irvine, CA (US); Sichen Li, Santa Ana, CA (US); Ju Gao, Newport Beach, CA (US); Jiuqi Wang, Santa Ana, CA (US); Han Qin, Newport Beach, CA (US); Jiayang Qin, Newport Beach, CA (US)

(21) Appl. No.: 18/168,447

(22) Filed: Feb. 13, 2023

(51) Int. Cl. H04B 7/26; H04B 1/036; H04W 48/20

(52) U.S. Cl. CPC H04B 7/2606; H04B 1/036; H04W 48/20

(57) ABSTRACT

An RV-based mobile base station system includes, within a recreational vehicle, a vehicular base station system, a vehicular satellite communication system, and a switching system to decide the current communication path. All base station and satellite devices can be installed on the backside of an RV, for example, with cooling and powering systems. This hybrid RV base station system is capable of detecting signal intensity and automatically picking the best signal backhaul link, ensuring daily communications (phone, text, cellular, and the like) of RVers and improving signal coverage for external users. Per the fast development tendency of the RV industry, the growing network of RV mobile base station has great potential to replenish blind spot coverages of the existing network carriers.

### BACKGROUND OF THE INVENTION

### 1. Field of the Invention

Embodiments of the invention relate generally to telecommunication devices. More particularly, embodiments of the invention relate to a mobile base station for telecommunication devices that can be used in a recreational vehicle (RV).

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Telecommunication as an indispensable part of modern life contributes to the safety and living quality of RVers, such as sending emergency beacons, watching favorite TV channels, and connecting to the Internet anytime and anywhere. However, signal strengths in the majority of RV parks and national parks are rarely sufficient. To solve this, signal booster can somehow amplify the weak signal but such devices will make no difference when within blind point of nearby access points. In such circumstances, a satellite communication system would be a great choice for keeping RVers connected to the world.

The increasing demand for stable and high-speed telecommunication poses great difficulties for the deployment of 4G LTE and 5G base stations across the country. Due to the short coverage distance of 5G signal, the number of 5G base stations must be about 3 times that of the 4G ones, if the same coverage of current 4G base stations is to be achieved. On the other hand, the maximum power consumption of a 5G base station is about 3-4 times that of a 4G one. So, in general, the total electricity cost of 5G base stations in the future will reach 9-10 times that of 4G.

As can be seen, there is a need for a RV-based switchable base station that can include satellite and base station communication modulus to greatly improve the communication quality of RVers.

### SUMMARY OF THE INVENTION

Embodiments of the present invention aim to solve the aforementioned problems in conventional telecommunication devices by providing a switchable system that includes satellite and base station communication modulus can greatly improve the communication quality of RVers. In addition, RVs equipped with the hybrid base station system have great potential to play the role as movable access points for LTE and 5G communications. Using RVs as mobile base stations for 5G can take advantage of their big used space and greatly reduce the time and money spent for deploying necessary components.

Embodiments of the present invention provide an RV-based mobile communication base station system comprising a satellite connection module operable to send and receive signals from a core network to a satellite communication device of an RV via a communications satellite; a base station connection module operable to send and receive signals from the core network to a base station communication device of the RV via a terrestrial base station; a signal strength test and comparison module operable to determine a better signal quality between the satellite connection module and the base station connection module; and a base station antenna operable to send and receive signals between one of the satellite connection module or the base station connection module and one or more mobile device users.

Embodiments of the present invention provide an RV-based mobile communication base station system comprising a satellite connection module operable to send and receive signals from a core network to a satellite communication device of an RV via a communications satellite; a base station connection module operable to send and receive signals from the core network to a base station communication device of the RV via a terrestrial base station; an RV base station connection module operable to send and receive signals from the core network to the base station communication device of the RV via a second base station antenna of a second RV equipped with the RV-based mobile communication base station system; a signal strength test and comparison module operable to determine a better signal quality between the satellite connection module, the base station connection module and the RV base station connection module; and a base station antenna operable to send and receive signals between one of the satellite connection module, the base station connection module, or the RV base station connection module and one or more mobile device users, wherein components of the system are contained within and movable with the RV; and the signal strength test and comparison module periodically checks the signal quality to re-determine the better signal quality between the satellite connection module, the base station connection module and the RV base station connection module.

Embodiments of the present invention provide a method for providing a communication network, comprising equipping a recreational vehicle (RV) with an RV-based mobile communication base station system comprising a satellite connection module operable to send and receive signals from a core network to a satellite communication device of an RV via a communications satellite; a base station connection module operable to send and receive signals from the core network to a base station communication device of the RV via a terrestrial base station; an RV base station connection module operable to send and receive signals from the core network to the base station communication device of the RV via a second base station antenna of a second RV equipped with the RV-based mobile communication base station system; a signal strength test and comparison module operable to determine a better signal quality between the satellite connection module, the base station connection module and the RV base station connection module; and a base station antenna operable to send and receive signals between one of the satellite connection module, the base station connection module, or the RV base station connection module and one or more mobile device users. The method further includes determining a better connection module having the better signal quality, the better connection module selected between the satellite connection module, the base station connection module and the RV base station connection module; using the better connection module to establish a communication connection; and permitting one or more users within a connection range of an RV base station antenna to connect to the communication connection.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates a communication mode for RVs through ground base station networks, according to an exemplary embodiment of the present invention;

FIG. 2 illustrates a communication mode for RVs through a satellite network, according to an exemplary embodiment of the present invention;

FIG. 3 illustrates a schematic representation of an RV-based mobile base station system, according to an exemplary embodiment of the present invention; and

FIG. 4 illustrates a block diagram of a signal strength test and comparison system for deciding which communication path to connect, according to an exemplary embodiment of the present invention.

The illustrations in the figures may not necessarily be drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide an RV-based mobile base station system that includes a recreational vehicle, a vehicular base station system, a vehicular satellite communication system, and a switching system to decide the current communication path. All base station and satellite devices can be installed on the backside of an RV, for example, with cooling and powering systems. This hybrid RV base station system is capable of detecting signal intensity and automatically picking the best signal backhaul link, ensuring daily communications (phone, text, cellular, and the like) of RVers and improving signal coverage for external users. Per the fast development tendency of the RV industry, the growing network of RV mobile base station has great potential to replenish blind spot coverages of the existing network carriers.

The figures are briefly described below, followed by a broader discussion of each figure and the components therein.

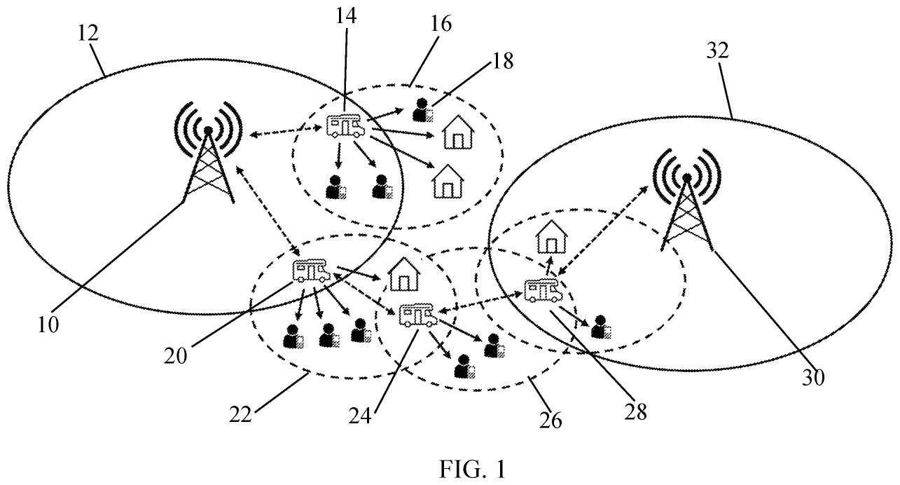

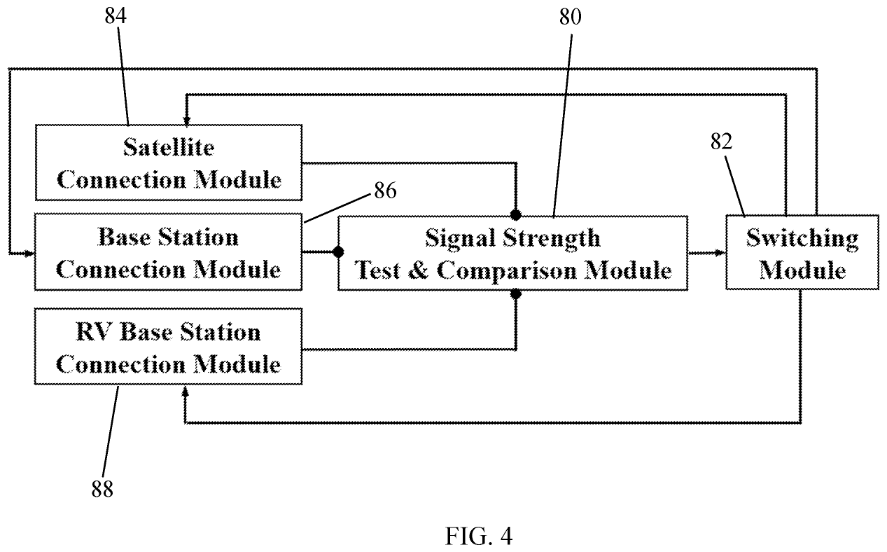

FIG. 1 shows a communication mode of RVs through ground base station networks. Within the range of nearby base station/access point, the base station antenna and the corresponding devices (such as a baseband unit (BBU), a remote radio unit (RRU) and/or an antenna (or active antenna unit (AAU), for example) integrated on an RV will establish a backhaul link with a ground access point and offer a stable and amplified communication signal to RVers and external users. Such backhaul link can be extended further through the connection of a number of RVs along the road, helping compensate for blind points due to the current loose deployment of base stations in the region. Furthermore, the embedded signal strength monitoring and comparison module, shown in FIG. 4, can assist an individual RV in picking the best communication link. For example, the RV located at the lower right corner of FIG. 1 can measure the signal strengths from the right base station and from the signal broadcasted by the middle RV (after getting permission of the user, as may be required). The comparison module can check the priority and then switch to the best connection path.

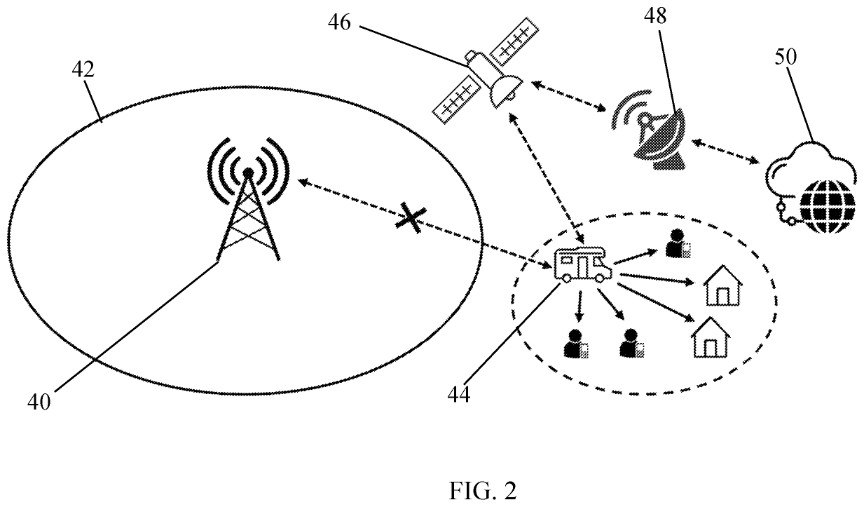

FIG. 2 describes telecommunication enabled via satellite. When an RV is located at a blind point of the existing ground base stations and there is no other RV mobile base station nearby (which is decided by the signal strength test and comparison system described in FIG. 4), the satellite communication system can be activated and can collaborate with the vehicular base station system to establish a backhaul link. To be specific, the signal received by the base station antenna can be transmitted to the vehicular satellite communication device through an IP interface protocol, and then sent to a communicational satellite in space through the vehicular satellite antenna. After that, the signal can be transmitted to the earth terminal, which is connected to the core network, forming a complete signal transceiving cycle. Although the high altitude of the satellite will make the signal somewhat delayed, there is no obvious influence on phone calls and texts. Once the RV moves to the coverage of a ground base station, it can automatically switch back and establish a communication path with the ground base station immediately (but this can also depend on the thresholds setup for different types of communication signals). In this way, the as described RV is able to be a functional base station anywhere in the state and can put interior and external telecom users in a communication state without dead zones.

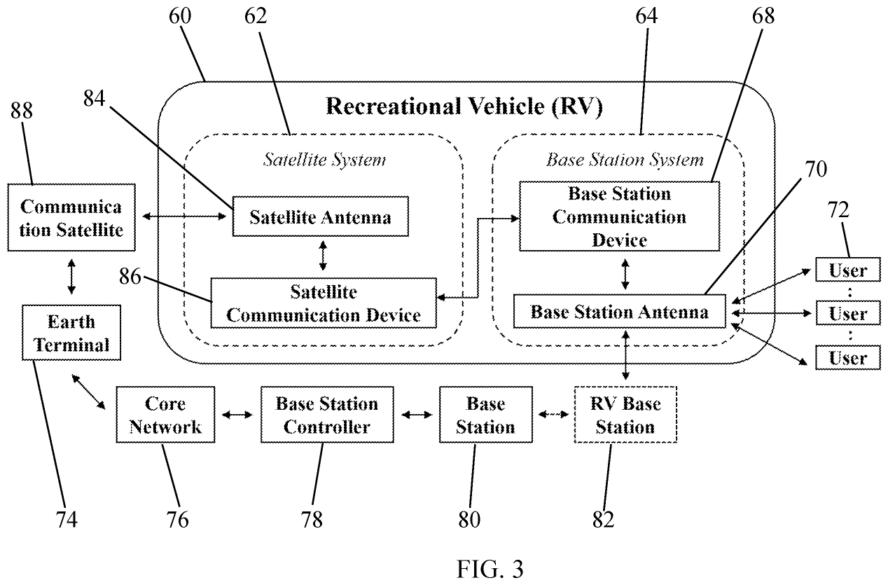

FIG. 3 illustrates a working schematic of an RV-based mobile base station system. Signal communication can be established through two paths, including satellite-RV mobile base station-user, and base transceiver station-RV mobile base station-user. Selection of the communication path is dependent on the detection of signal intensity of nearby base transceiver station.

FIG. 4 illustrates a diagram of a signal strength test and comparison system for deciding which communication path to connect for RVers. Such a module embedded close to the RV external antenna system can detect the signal strengths from three different approaches, including signals from a paired satellite, a base transceiver station, and an RV mobile base station, as described herein. Thresholds for these different signals can be predefined and/or user-selected and can be utilized to compare whether to switch the connection status between these communication options. Such a signal strength test and comparison module can be activated periodically to ensure the best signal communication for the RVers and external users.

Referring back to FIGS. 1 and 2, a communication network is illustrated with a first RV 14, a second RV 20, a third RV 24 and a fourth RV 28 can act as base stations for communications. Each of the RVs 14, 20, 24, 28 may act as a communications base station, permitting users 18 to access a communications network. As used herein, reference to the RV itself may also be understood to refer to the base station system present in such an RV. The base stations may include the components required for receiving and transmitting information. For example, the base stations may include an AAU or RRU and antenna device, an additional parabolic or other satellite antenna to enable wireless transmission via a satellite network, a BBU, and the like.

As can be seen in the example of FIG. 1, the first and second RVs 14, 20 are within a communication range 12 of a ground-based base station antenna 10. Thus, the first and second RVs 14, 20 can generate their own communication ranges 16, 22. The third RV 24 is outside of the communication range 12 of the ground-based base station antenna 10, but is within the communication range 22 of the second RV 20. Thus, access to a communications network would be available at the third RV 24 via the second RV 24. The fourth RV 28 may be within a communication range 32 of a second ground-based base station antenna 30 and also with in a communication range 26 of the third RV 24. A switching system, as described in greater detail below, can determine a signal quality of each of the third RV 24 and the second ground-based base station antenna 30 to determine which system to connect. The signal quality may be determined by a number of factors, such as on or more of signal strength, latency, signal noise, or the like.

In FIG. 2, a ground-based based station antenna 40 may have a communication range 42, where an RV 44 is outside of the communication range 42. The RV-based base station system of the present invention may include a switching system, as described below, to determine that a signal is available via satellite 46 and the RV 44 may use a satellite communication system (see FIG. 3) to establish a backhaul link. The satellite 46 can transmit the signal to an earth terminal 48 that is connected to the core network 50. Further, the RV 44 can also provide its own communication range 52 so that users 54 within this communication range 52 may have access to the communications network via the RV 44 and the satellite 46.

In embodiments where the RV 44 is mobile, a signal strength test and comparison system, as part of the RV-based base station system, can periodically check to determine if a terrestrial communication antenna has a better quality signal and can switch the communications to be affected through a ground-based base station antenna.

Referring to FIG. 3, an RV 60 can include both a satellite system 62 and a base station system 64. The base station system 64 can include a base station communication device 68 and a base station antenna 70 that may provide communication access to one or more users 72. The base station antenna 70 may communicate with the RV base station 82 that may then communicate with a ground-based base station 80, which, in turn, may have its own base station controller 78 to communicate with a core network 76.

The satellite system 62 can include a satellite communication device 86 and a satellite antenna 84. The satellite antenna 84 may communicate with a communication satellite 88, which, in turn, can communicate with an earth terminal 74 which is itself connected to the core network 76. Thus, both the satellite system 62 and the RV base station 82 can communicate with the core network 76. Further, as described below, the RV base station 82 can communicate with a base station antenna of another RV equipped with the RV-based base station system, should such an RV be within a communication range with the RV 60.

Referring to FIG. 4, the RV-based base station system can include a signal strength test and comparison module. This module can receive input from a satellite connection module 84, a base station connection module 86, and an RV base station connection module 88 to determine which connection module 84, 86, 88 may have the best signal quality. A switching module 82 may switch between the modules 84, 86, 88 based on the result from the signal strength test and comparison module 80. Thus, an RV equipped with the RV-based base station system of the present invention may establish communications with either (1) a terrestrial-based antenna (via base station connection module 86), (2) a communication satellite (via the satellite connection module 84), or (3) with another RV having the RV-based base station system (via the RV base station connection module 88). The RV-based base station system can continuously or periodically monitor the signal quality from one or all of these sources and switch the communication source accordingly. The basis for choosing one of the communications networks and the basis for switching networks may be predetermined or may be user-selectable. For example, if a cost for satellite communication is relatively expensive, the user may only desire such a communication connection only when the other possibilities are not available (for example, even if the overall signal quality is better via satellite).

In some embodiments, the RV-based base station system may include an indicator, available to the RV user, to see what communication pathway is available and to which communication pathway the RV is currently connected. The RV-based base station system may further include various diagnostics as may be known in the art. For example, a user may be able to see various features of each network (such as upload and download speeds, latency, and the like). Such diagnostics may also track connection times, total data throughput, and the like. Further, the user may be able to select whether others can connect or how they may connect. For example, a user may limit their connection range when they are using satellite communications.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. An RV-based mobile communication base station system comprising:
a satellite connection module operable to send and receive signals from a core network to a satellite communication device of an RV via a communications satellite;
a base station connection module operable to send and receive signals from the core network to a base station communication device of the RV via a terrestrial base station;
a signal strength test and comparison module operable to determine a better signal quality between the satellite connection module and the base station connection module; and
a base station antenna operable to send and receive signals between one of the satellite connection module or the base station connection module and one or more mobile device users.

2. The system of claim 1, further comprising an RV base station connection module operable to send and receive signals from the core network to the base station communication device of the RV via a second base station antenna of a second RV equipped with the RV-based mobile communication base station system, wherein
the signal strength test and comparison module is operable to determine a better signal quality between the satellite connection module, the base station connection module and the RV base station connection module; and
the base station antenna is operable to send and receive signals between one of the satellite connection module, the base station connection module or the RV base station communication module and one or more mobile device users.

3. The system of claim 1, wherein the signal quality includes at least one of a signal intensity, a data transmission speed and signal latency.

4. The system of claim 1, wherein the signal strength test and comparison module includes predetermined thresholds for determining the better signal quality.

5. The system of claim 1, wherein the signal strength test and comparison module includes user-adjustable thresholds for determining the better signal quality.

6. The system of claim 2, wherein the signal strength test and comparison module periodically checks the signal quality to re-determine the better signal quality between the satellite connection module, the base station connection module and the RV base station connection module.

7. The system of claim 2, wherein the signal strength test and comparison module continually checks the signal quality to re-determine the better signal quality between the satellite connection module, the base station connection module and the RV base station connection module.

8. The system of claim 1, wherein components of the system are contained within the RV.

9. The system of claim 7, wherein the components include a cooling system and a power supply.

10. The system of claim 2, wherein the signal strength test and comparison module automatically switches to communications via the base station connection module or the RV base station connection module when available.

11. An RV-based mobile communication base station system comprising:
a satellite connection module operable to send and receive signals from a core network to a satellite communication device of an RV via a communications satellite;
a base station connection module operable to send and receive signals from the core network to a base station communication device of the RV via a terrestrial base station;
an RV base station connection module operable to send and receive signals from the core network to the base station communication device of the RV via a second base station antenna of a second RV equipped with the RV-based mobile communication base station system;
a signal strength test and comparison module operable to determine a better signal quality between the satellite connection module, the base station connection module and the RV base station connection module; and
a base station antenna operable to send and receive signals between one of the satellite connection module, the base station connection module, or the RV base station connection module and one or more mobile device users, wherein
components of the system are contained within and movable with the RV; and
the signal strength test and comparison module periodically checks the signal quality to re-determine the better signal quality between the satellite connection module, the base station connection module and the RV base station connection module.

12. The system of claim 11, wherein the signal quality includes at least one of a signal intensity, a data transmission speed and signal latency.

13. The system of claim 11, wherein the signal strength test and comparison module includes predetermined thresholds for determining the better signal quality.

14. The system of claim 11, wherein the signal strength test and comparison module includes user-adjustable thresholds for determining the better signal quality.

15. The system of claim 11, wherein the signal strength test and comparison module automatically switches to communications via the base station connection module or the RV base station connection module when available.

16. A method for providing a communication network, comprising:
equipping a recreational vehicle (RV) with an RV-based mobile communication base station system comprising:
a satellite connection module operable to send and receive signals from a core network to a satellite communication device of an RV via a communications satellite;
a base station connection module operable to send and receive signals from the core network to a base station communication device of the RV via a terrestrial base station;
an RV base station connection module operable to send and receive signals from the core network to the base station communication device of the RV via a second base station antenna of a second RV equipped with the RV-based mobile communication base station system;
a signal strength test and comparison module operable to determine a better signal quality between the satellite connection module, the base station connection module and the RV base station connection module; and
a base station antenna operable to send and receive signals between one of the satellite connection module, the base station connection module, or the RV base station connection module and one or more mobile device users;
determining a better connection module having the better signal quality, the better connection module selected between the satellite connection module, the base station connection module and the RV base station connection module;
using the better connection module to establish a communication connection; and
permitting one or more users within a connection range of an RV base station antenna to connect to the communication connection.

17. The method of claim 16, further comprising permitting a second RV, equipped with a second RV-based base station system, to establish a second communication connection via communication with the RV base station antenna.

18. The method of claim 17, further comprising establishing a second connection range of a second RV base station antenna of the second RV.

19. The method of claim 18, further comprising permitting one or more additional users within the second connection range of the second RV base station antenna to connect to the communication connection.
